(19) United States
(12) Patent Application Publication
(10) Pub. No.: US 2008/0141262 A1
(43) Pub. Date: Jun. 12, 2008

(54) SYSTEM, APPARATUS, AND METHOD FOR MANAGING A SERVICE

(76) Inventor: Kenji MORIHARA, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/767,030

(22) Filed: Jun. 22, 2007

(30) Foreign Application Priority Data
Dec. 7, 2006 (JP) 2006-330452

(51) Int. Cl. G06F 9/46

(52) U.S. Cl. 718/104

(57) ABSTRACT

A service managing system includes a plurality of business computers, and a service managing apparatus communicably connected to the business computers. A processing unit in the service managing apparatus references influence information, configuration information, and operating process information stored in a storage unit, when the processing unit instructs a start-up of a process to any of the business computers. The processing unit then identifies any other process(es) and its corresponding service(s) to be influenced by the start-up instruction.

### CROSS REFERENCE TO RELATED APPLICATIONS

This application claims the benefit of Japanese Patent Application No. 2006-330452 filed on Dec. 7, 2006, the disclosure of which is incorporated herein by reference.

### BACKGROUND OF THE INVENTION

1. Field of the Invention

The present invention relates to a technique in which, when a business computer includes a plurality of business programs, and each of the different business programs constitutes a plurality of different services, an influence of a command to be executed to a service on the other service(s) is detected, before the command is actually executed.

2. Description of the Related Art

In recent years, many business corporations establish a single system for managing a plurality of business systems such as an ordering system and an accounting system. Many data centers establish a single system for managing a plurality of business systems outsourced by a plurality of business corporations. Namely, a single system often includes a plurality of different business systems (The business system may also be hereinafter referred to as a “service”).

Business programs which constitute a plurality of services may be constructed within a single business computer, so as to make an efficient use of a business computer resource and reduce its management cost, regardless of which program constitutes which service. Namely, a plurality of business programs constituting a plurality of different services often exist in a single business computer.

Operations and management of such a system environment as described above may be performed not on a business computer basis but on a service basis. This allows an earlier detection of a service affected by a failure of the system, and an easier configuration change of hardware/software owing to a change in contents of the service (see, for example, Japanese Laid-Open Patent Application, Publication No. 2001-34488).

In operations and management of a system on the service basis, an administrator knows which services and business programs constituting each service are how constructed in a business computer, before the administrator executes a command to a business program constituting a target service in the business computer.

However, before the administrator executes the command to the target service, the administrator has to check the following: (1) whether or not the command to be executed exerts an influence on the other business program(s) constituting the other service(s) in the business computer; and (2) if the command is found to exert an influence on the other business program, an operating status of a process corresponding to the other business programs. If the other business program runs in a different process (namely, if the program is in execution), the command will not exert an influence on the other business program. Hence the administrator may execute the command. In either case, the administrator has to perform a complicated checking operation before executing the command. Further, if the administrator fails to perform an appropriate checking operation, the other business program and/or service may receive an undesirable influence.

In light of the above-mentioned problems, the present invention has been made in an attempt to detect, when a start-up instruction via a command or the like is executed to a target service in a system in which a plurality of services exist, whether or not the start-up instruction exerts an influence on the services other than the target service.

### SUMMARY OF THE INVENTION

An aspect of the present invention is a service managing system. The service managing system includes a plurality of business computers, each of which provides a plurality of services, each of which is constituted by a plurality of business programs; and a service managing apparatus communicably connected to each of the business computers.

The service managing apparatus includes a processing unit and a storage device. The storage device stores influence information, configuration information, and operating process information, on each of the services. On the influence information, data on start-up instructions of processes, and processes not instructed to start up but influenced by the start-up instructions are stored and are associated with each other. On the configuration information, data on the business computers and processes by which the business computers are started up are stored and are associated with each other. On the operating process information, data on the business computers and process IDs assigned to processes in the business computers used by the services are stored and are associated with each other.

The processing unit references the influence information, configuration information, and operating process information stored in the storage device, when the processing unit gives a start-up instruction of a process to any of the business computers. Thus the processing unit identifies a process (es) and its corresponding service(s) influenced by the start-up instruction.

Other features and advantages of the present invention will become more apparent from the following detailed description of the invention, when taken in conjunction with the accompanying exemplary drawings.

### BRIEF DESCRIPTION OF THE DRAWINGS

FIG. 1 is a general block diagram showing a service managing system in an embodiment of the present invention.

FIG. 2 is a block diagram showing hardware configuration of a service managing apparatus and a service monitoring device in the embodiment.

FIG. 3 is a block diagram showing hardware of a business computer in the embodiment.

FIG. 4 is a diagram showing a system configuration in the embodiment.

FIG. 5 is a diagram showing correspondence between business program names and process names in the embodiment.

FIG. 6 is a diagram showing an influence table which is created on each service in the embodiment.

FIG. 7 is a diagram showing a configuration table which is created on each service in the embodiment.

FIG. 8 is a diagram showing an operating process table which is created on each service in the embodiment.

FIG. 9 is a flowchart showing a procedure of registering a process ID of a started-up process into the operating process table, carried out by a service start-up managing unit in the embodiment.

FIG. 10 is a diagram showing a start-up request message in the embodiment.

FIG. 11 is a diagram showing an operating process ID list in the embodiment.

FIG. 12 is a flowchart showing a procedure of creating the operating process ID list, carried out by a service managing agent unit in the embodiment.

FIG. 13 is a diagram showing an executed command influence detection message in the embodiment.

FIG. 14 is a flowchart showing a procedure of determining an influence of the command execution on the other services, when a command is executed to a service. The procedure is carried out by a command influence determining unit in the embodiment.

FIG. 15 is a flowchart showing a procedure of obtaining conflicting service names and process names thereof. The procedure is carried out by a conflicting service detecting unit in the embodiment.

FIG. 16 is a flowchart showing a procedure of executing a command in case of no influence exerted on the other service. The procedure is carried out by a command execution unit in the embodiment.

FIG. 17 is a diagram showing a conflicting service list in the embodiment.

FIG. 18 is a diagram showing a display screen for displaying a detected influence of the command executed in the embodiment.

### DETAILED DESCRIPTION OF EXEMPLARY EMBODIMENT

With reference to the related drawings, an exemplary embodiment of the present invention is described, in which, when a command (a start-up instruction) is executed to a service, a service managing system automatically detects an influence on the other service(s).

A command used herein means a set of character strings with which a user (an administrator) directly gives an instruction to a business program. More specifically, the command includes a set of character strings representing an operating instruction provided by a business program, an operating instruction provided by an operating system (hereinafter referred to as an OS), and an operating instruction provided by a user such as a simplified program in which a recovery procedure from a failure, an install procedure, or the like is described in a computer-executable format.

A command (a start-up instruction) may be executed not only by a direct typing of the command, but also by an input operation on a display screen on which contents of the command such as “transfer the software” may be displayed.

A process used herein means a program in execution. When a process constituting a business program is started up, the business program works.

An operating process ID is herein assigned to a name of each process constituting a business program. The operating process ID is a value unique to each business computer, and is assigned by an OS so as to identify a process to be operated.

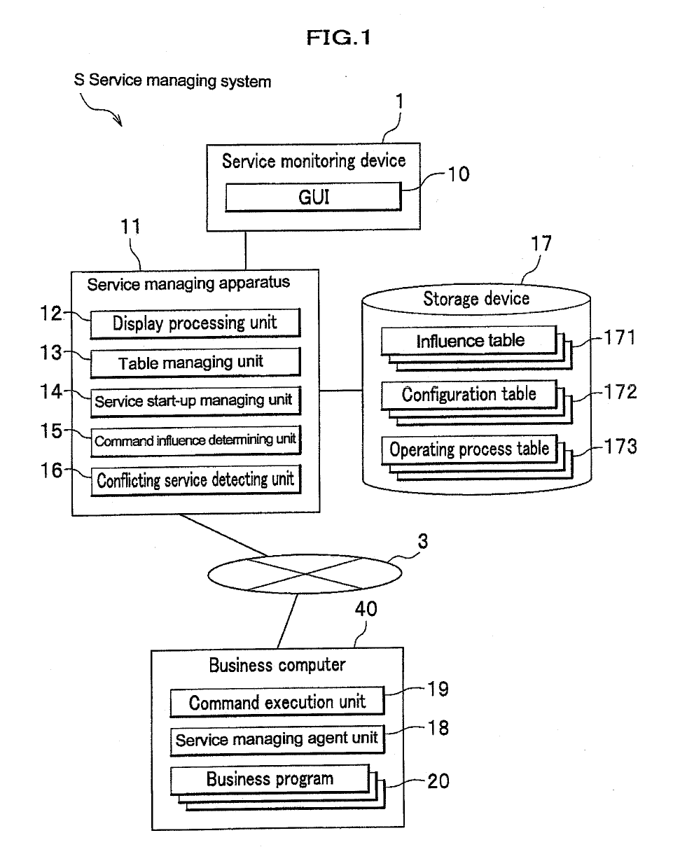

FIG. 1 is a general block diagram showing a service managing system in the embodiment. As shown in FIG. 1, a service managing system S includes a service monitoring device 1 (externally equipped), a service managing apparatus 11, and a plurality of business computers 40 (only one is shown). The service managing apparatus 11 and each of the plurality of business computers 40 are connected via a network 3. A storage device 17 may be either incorporated in the service managing apparatus 11, or externally equipped.

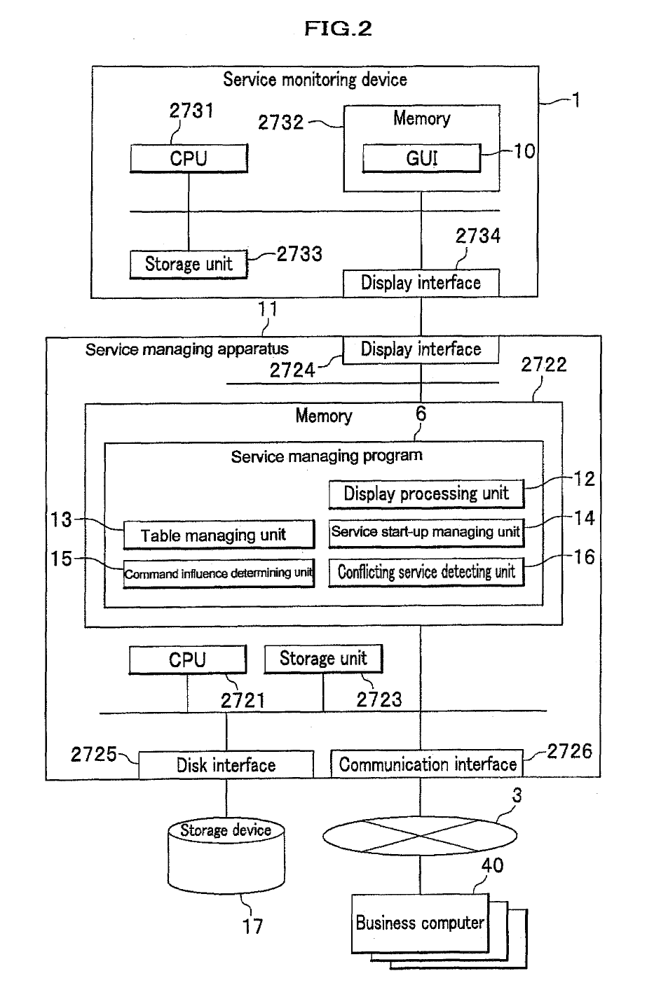

The service monitoring device 1 includes a GUI (Graphical User Interface) 10. The GUI displays, on each service, names of the business computers 40 used for the services, and names of business programs in the business computers 40; operation screens for starting up a business program constituting a service, for executing a command to a business computer constituting the service, and the like; and a service(s) on which the command to be executed exerts an influence. Hardware configuration of the service monitoring device 1 will be described later with reference to FIG. 2.

FIG. 1 shows one unit of the service monitoring device 1. However, a plurality of the service monitoring devices 1 may be provided, each of which is connected to the service managing apparatus 11, and is operated by a plurality of different administrators.

The service monitoring device 1 may be integrated with or incorporated in the service managing apparatus 11.

The service managing apparatus 11 includes a display processing unit 12, a table managing unit 13, a service start-up managing unit 14, a command influence determining unit 15, and a conflicting service detecting unit 16.

The display processing unit 12 serves as a processing unit. The display processing unit 12 makes the GUI 10 in the service monitoring device 1 display names of the business computers 40 on each service, information on configuration of business programs and process names, information on processes influenced by an executed command, and results of the influence exerted by the executed command.

The table managing unit 13 also serves as a processing unit. The table managing unit 13 manages the following tables on each service, and reads and writes various data. The tables include an influence table 171 (influence information), a configuration table 172 (configuration information), and an operating process table 173 (operating process information), all of which are held in the storage device 17.

The service start-up managing unit 14 also serves as a processing unit. The service start-up managing unit 14 receives a start-up request (instruction) of a service from the GUI 10; obtains a business program in the business computer 40 registered in the configuration table 172 for a target service; communicates with a service managing agent unit 18 in the business computer 40; makes a start-up request of a process on the target service; obtains a process ID assigned to the started-up process; and creates the operating process table 173 including the process ID.

The command influence determining unit 15 also serves as a processing unit. The command influence determining unit 15 communicates with the GUI 10 and a command execution unit 19 in the business computer 40, and sends thereto and receives therefrom a command to be executed to a target service. The command influence determining unit 15 obtains, from the conflicting service detecting unit 16, information on an influence of the command received from the GUI 10 on the service(s) in the business computers 40, other than on the target service; and creates a message to the GUI 10 or the command execution unit 19, and sends various data.

The conflicting service detecting unit 16 also serves as a processing unit. The conflicting service detecting unit 16 detects whether or not the command to be executed exerts an influence on the other services, using the tables 171, 172,173 stored in the storage device 17.

The influence table 171 holds process names corresponding to the business programs 20 in a service on which a command exerts an influence. The configuration table 172 holds configuration information on processes corresponding to the business programs 20, which constitute a target service, in the business computers 40. The operating process table 173 holds process IDs assigned to process names in the configuration table 172 on each service.

Each of the business computers 40 includes a plurality of business programs 20, the service managing agent unit 18, and the command execution unit 19. The business programs 20 are execution programs for providing services. A service uses a plurality of the business programs 20, each of which may be provided in different business computers 40.

The service managing agent unit 18 also serves as a processing unit. The service managing agent unit 18 receives data on processes to be started up, from the service start-up managing unit 14 in the service managing apparatus 11, and starts up each process in the data. The service managing agent unit 18 also obtains process IDs which are assigned to the started-up processes by the OS, and sends the process IDs to the service start-up managing unit 14.

The command execution unit 19 also serves as a processing unit. The command execution unit 19 receives data on the command to be executed to a target service and executes the command, when the command influence determining unit 15 in the service managing apparatus 11 determines that the command does not exert any influence on the other services.

FIG. 2 is a block diagram showing hardware configuration of the service monitoring device 1 and the service managing apparatus 11 in the embodiment. The service managing apparatus 11 includes a CPU (a central processing unit) 2721 (a processing unit), a memory 2722 (a storage unit), a storage unit 2723 (a storage unit), a display interface 2724, a disk interface 2725, and a communication interface 2726. The service monitoring device 1 includes a CPU 2731, a memory 2732, a storage unit 2733, and a display interface 2734.

The service managing program 6 operates, when the CPU 2721 loads programs stored in the storage unit 2723 onto the memory 2722, and executes the programs. The service managing apparatus 11 is connected to the externally equipped storage device 17 (a storage unit) via the disk interface 2725, and is connected to the business computers 40 via the communication interface 2726 and the network 3.

In the service monitoring device 1, the GUI 10 operates, when the CPU 2731 loads programs stored in the storage unit 2723, onto the memory 2833, and executes the programs.

The influence table 171, configuration table 172, and operating process table 173 shown in FIG. 1 are stored in the storage device 17.

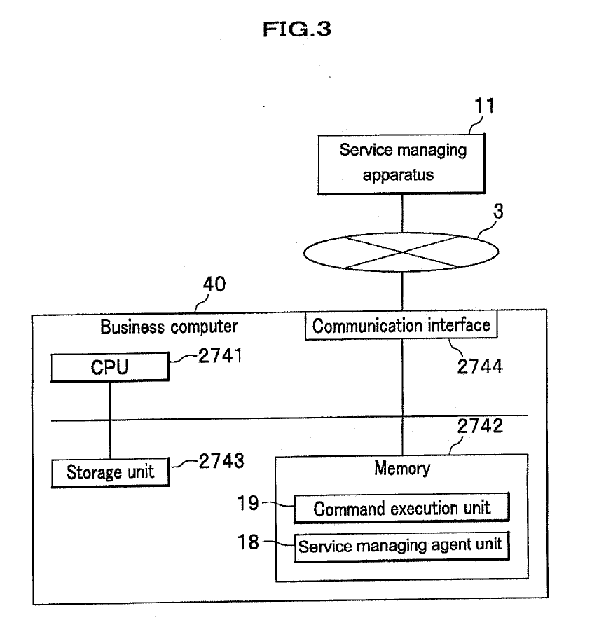

FIG. 3 is a block diagram showing hardware configuration of the business computer 40 in the embodiment. In the business computer 40, the service managing agent unit 18 and the command execution unit 19 operate via a CPU 2741, a memory 2742, a storage unit 2743, and a communication interface 2744. Namely, the service managing agent unit 18 and the command execution unit 19 operate, when the CPU 2741 loads program stored in the storage unit 2743 onto the memory 2742, and executes the programs. The business computer 40 is connected to the service managing apparatus 11 via the communication interface 2744 and the network 3.

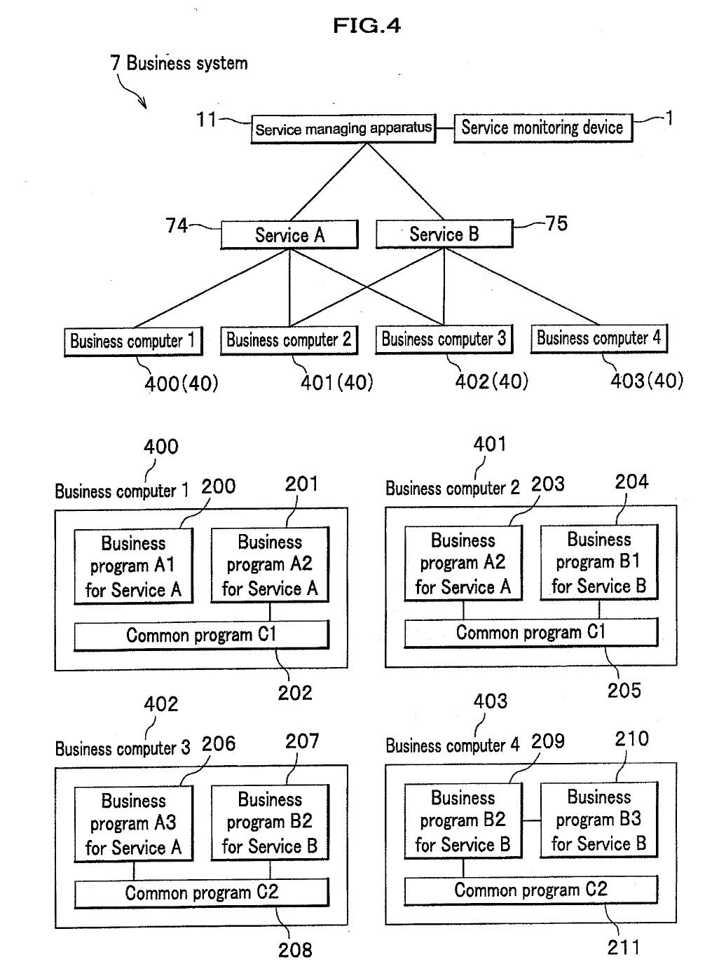

FIG. 4 is a diagram showing a system configuration in the embodiment.

A business system 7 includes business computers 1 (400) to 4 (403), which correspond to the business computers 40 in FIG. 1. The business computers 1 (400) to 4 (403) constitute service A (74) and service B (75). More specifically, the business computers 1 (400) to 3 (402) constitute the service A (74), and the business computers 2 (401) to 4 (403) constitute the service B (75). Thus each of the business computer 2 (401) and the business computer 3 (402) constitutes both the service A (74) and the service B (75).

The service managing apparatus 11 manages the business system 7 on a service basis. The administrator monitors the business system 7 in a unified manner via the service monitoring device 1. The business computers 1 (400) to 4 (403) are provided with business programs 200 to 211, each of which constitute the services A,B.

The business computer 1 (400) has a common program C1 (202); a business program A1 (200) which is used by the service A (74) and operates solely (not based on the common program C1 (202) as a prerequisite program); and a business program A2 (201) for the service A, based on the common program C1 (202) as a prerequisite program.

The business computer 2 (401) has a common program C1 (205); a business program A2 (203) for the service A, based on the common program C1 (205) as the prerequisite program; and a business program B1 (204) for the service B, based on the common program C1 (205) as the prerequisite program.

It is to be noted herein that, if names of the programs (such as “C1”) are the same, contents of the programs are the same. For example, the common program C1 (202) and the common program C1 (205) have the same contents, even though reference numbers thereof (202) and (205) are different.

The business computer 3 (402) has a common program C2 (208); a business program A3 (206) for the service A based on the common program C2 (208) as a prerequisite program; and a business program B2 (207) for the service B, based on the common program C2 (208) as the prerequisite program.

The business computer 4 (403) has the common program C2 (211); the business program B2 (209) for the service B, based on the program C2 (211) as the prerequisite program; and a business program B3 (210), based on the business program B2 (209) as a prerequisite program.

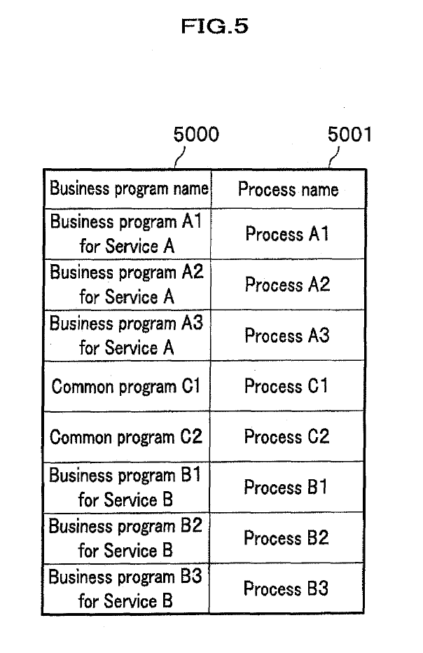

FIG. 5 is a diagram showing correspondence between a business program name (5000) (the business program 200 to 211 shown in FIG. 4) and a process name (5001) of which process constitutes each business program.

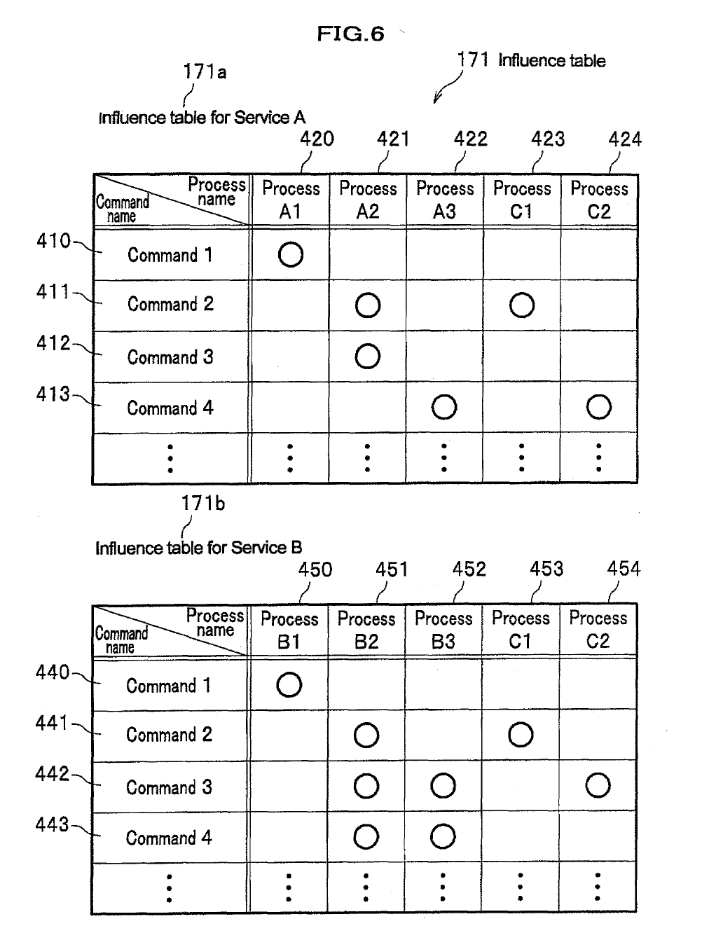

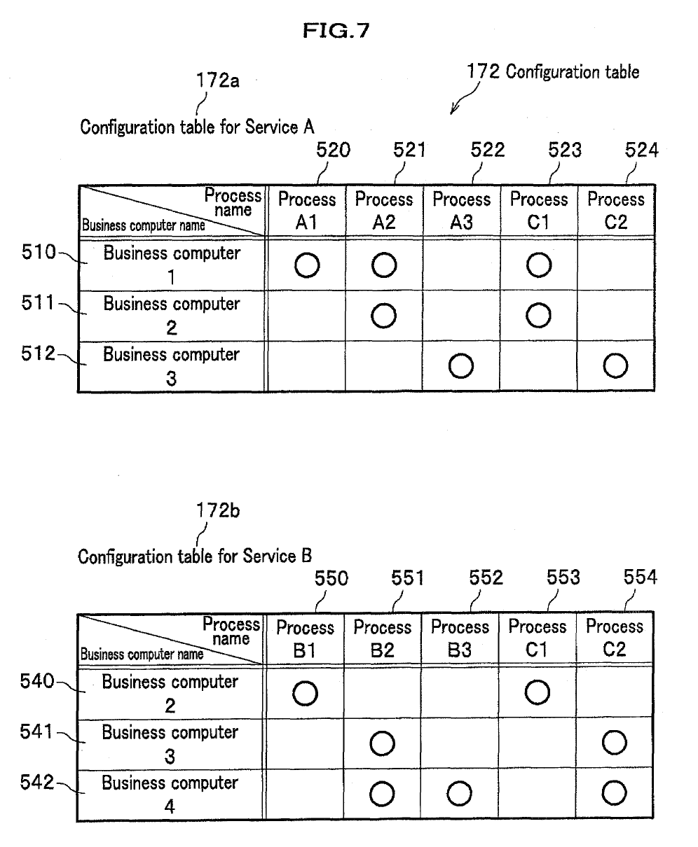

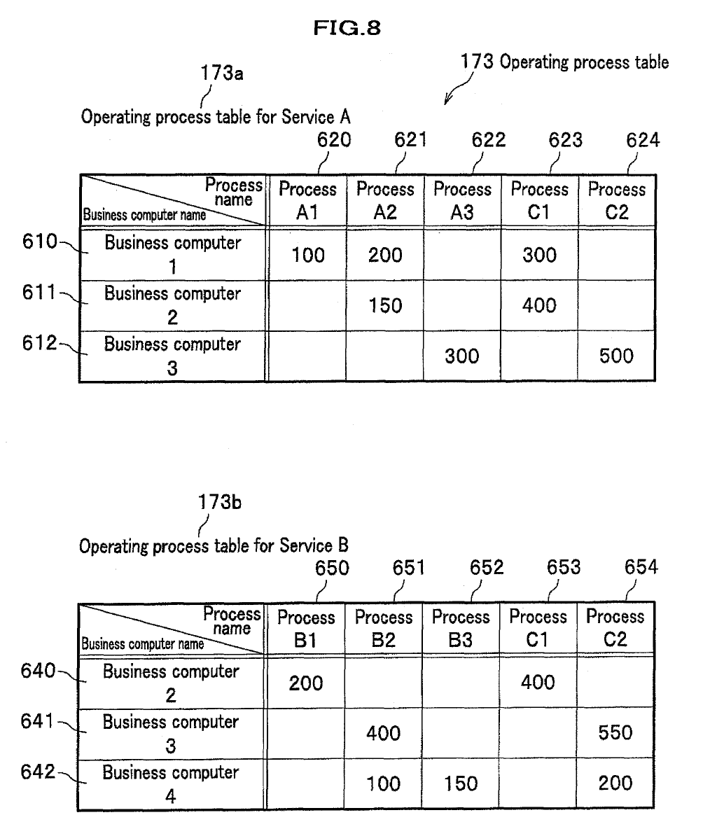

In the business computer 1 (400), the process name of the business program A1 (200) for the service A is process A1, that of the business program A2 (201) for the service A is process A2, and that of the common program C2 (292) is process C1. In the business computer 2 (401), the process name of the business program A2 (203) for the service A is process A2, that of the common program C1 (202) for the service A is process C1, and that of the business program B1 (204) for the service B is process B1. In the business computer 3 (402), the process name of the business program A3 (206) for the service A is process A3, that of the business program B2 (207) for the service B is process B2, and that of the common program C2 (208) is process C2. In the business computer 4 (403), the process name of the business program B2 (209) for the service B is process B2, that of the business program B3 (210) for the service B is process B3, and that of the common program C2 (211) is process C2. Process names shown in FIG. 6, FIG. 7 and FIG. 8 have the same correspondence as that shown in FIG. 5.

FIG. 6 is a diagram showing the influence table 171, which is created on each service and is held by the storage device 17.

The influence table 171 holds association between a name of a command to be executed and a name of a process on which the command exerts an influence. The administrator defines (and inputs in advance) the association in the influence table 171 on each service to be managed, for example, an influence table 171a for the service A and an influence table 171b for the service B shown in FIG. 6.

In creating the influence table 171a for the service A (74) the administrator inputs commands 1 (410) to 4 (413) and process names A1 (420) to C2 (424). Then the administrator puts open circles in appropriate columns where the command names and process names meet, processes of which exert an influence on the service A (74) when the respective commands 1 (410) to 4 (413) are executed.

Similarly, in creating the influence table 171b for the service B (75), the administrator inputs commands 1 (440) to 4 (443) and process names B1 (450) to C2 (454). Then the administrator puts open circles in appropriate columns where the command names and process names meet, processes of which exert an influence on the service B (75) when the respective commands 1 (440) to 4 (443) are executed.

For example, the influence table 171a for the service A (74) shows that, when the command 2 (411) is executed, the process A2 (421) and process C1 (423) receive an influence thereof. Similarly, the influence table 171b for the service B (75) shows that, when the command 2 (441) is executed, the process B2 (451) and process C1 (453) receive an influence thereof.

Herein an influence which a process receives means that, if a command, which is executed for a start-up, a stop or a change of the process A, not only the process A but also the process B, which is associated with the process A, are started up, stopped or changed.

FIG. 7 is a diagram showing the configuration table 172, which is created on each service and is held by the storage device 17.

The configuration table 172 holds configuration between names of business computers constituting each service, and process names corresponding to the business programs 200 to 211 on each service in the business computers 1 (400) to 4 (403). The administrator defines (and inputs in advance) the configuration in the configuration table 172 on each service to be managed, for example, a configuration table 172a for the service A and a configuration table 172b for the service B shown in FIG. 7.

In creating the configuration table 172a for the service A (74), the administrator inputs names of the business computers 1 (510) to 3 (512) used for the service A (74), and process names A1 (520) to C2 (524) corresponding to the business programs constituting the service A (74) in the respective business computers 1 (400) to 3 (402). Then the administrator puts open circles in appropriate columns where the business computers have corresponding process names.

Similarly, when in creating the configuration table 172b for the service B (75), the administrator inputs names of the business computers 2 (540) to 4 (542) used for the service B (75), and process names B1 (550) to C2 (554) corresponding to the business programs constituting the service B (75) in the respective business computers 2 (401) to 4 (403). Then the administrator puts open circles in appropriate columns where the business computers have corresponding process names.

For example, the configuration table 172a for the service A (74) shows that the business computer 2 (511) has the process A2 (521) and process C1 (523), which are the names of the processes corresponding to the business programs constituting the service A (74). Similarly, the configuration table 172b for the service B (75) shows that the business computer 2 (540) has the process B1 (550) and process C1 (553), which are the names of the processes corresponding to the business programs constituting the service B (75).

FIG. 8 is a diagram showing the operating process table 173, which is created on each service and is held by the storage device 17.

The operating process table 173 is created based on the configuration table 172. The operating process table 173 holds process IDs of the process names A1 (620) to C2 (624). The process IDs are assigned when the OS starts up the processes having the process names A1 (620) to C2 (624) corresponding to the business programs 200 to 211 (see FIG. 4) in the business computers 1 (610) to 3 (612). More specifically, the administrator operates the GUI 10 of the service monitoring device 1 to make a start-up request of a target service to the service start-up managing unit 14. When the service start-up managing unit 14 receives the start-up request, the service start-up managing unit 14 obtains process IDs from the service managing agent unit 18 in each of the business computers 40, and registers the process IDs in the operating process table 173. The operating process table 173 is created on each service, for example, an operating process table 173a for the service A and an operating process table 173b for the service B shown in FIG. 8.

The operating process table 173a for the service A (74) is created by filling process IDs in the columns where the open circles are put in the configuration table 172a of FIG. 7. The process IDs are obtained when the process names A1 (520) to C2 (524) (see FIG. 7) are started up.

Similarly, the operating process table 173b for the service B (75) is created by filling process IDs in the columns where the open circles are put in the configuration table 172b of FIG. 7. The process IDs are obtained when the process names B1 (550) to C2 (554) (see FIG. 7) are started up.

For example, the operating process table 173a for the service A (74) shows that the business computer 2 (611) has a process ID value of “150”, with which the process A2 (621) is started up, and a process ID value of “400”, with which the process C1 (623) is started up. Herein the process A2 (621) and process C1 (623) are process names corresponding to the business programs constituting the service A (74). Similarly, the operating process table 173b for the service B (75) shows that the business computer 2 (641) has a process ID of “200”, with which the process B1 (650) is started up, and a process ID of “400”, with which the process C1 (653) is started up. Herein the process B1 (650) and process C1 (653) are process names corresponding to the business programs constituting the service B (75). FIG. 8 shows that the common program C1 (205) (see FIG. 4) in the business computer 2 (401), which is used for both the service A (74) and the service B (75) (namely, the process C1 (623) in the operating process table 173a and the process C1 (653) in the operating process table 173b) has the same process IDs of “400” in the operating process tables 173a,173b. This means that the common program C1 (205) operates in the same process C1 for both the service A (74) and service B (75).

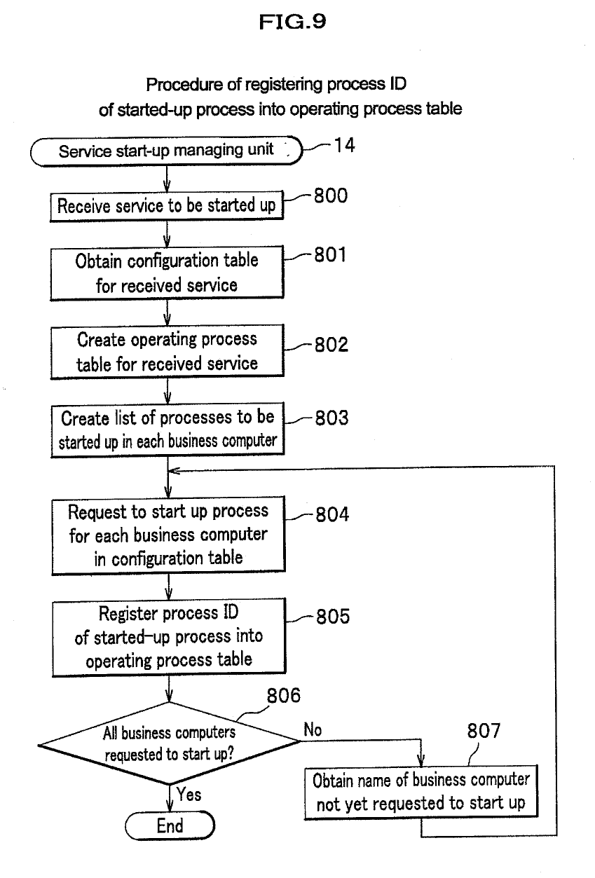

FIG. 9 is a flowchart showing a procedure of registering a process ID of a started-up process into the operating process table, carried out by the service start-up managing unit 14 in the service managing apparatus 11. In the procedure, the service start-up managing unit 14 receives a start-up request of a service from the administrator via the GUI 10 in the service monitoring device 1; makes a start-up request of a process constituting the service; obtains a process ID of the started-up process; and registers the obtained process ID in the operating process table 173.

In step 800, the service start-up managing unit 14 receives a name of a service to be started up from the administrator via the GUI 10. Then the procedure advances to step 801.

In step 801, the service start-up managing unit 14 obtains the configuration table 172 (see FIG. 7) corresponding to the service name received in step 800. Then the procedure advances to step 802.

In step 802, the service start-up managing unit 14 copies names of the business computers and process names held in the business computers in the configuration table 172 (see FIG. 7) obtained in step 801, and creates the operating process table 173 (see FIG. 8) therefrom. Then the procedure advances to step 803.

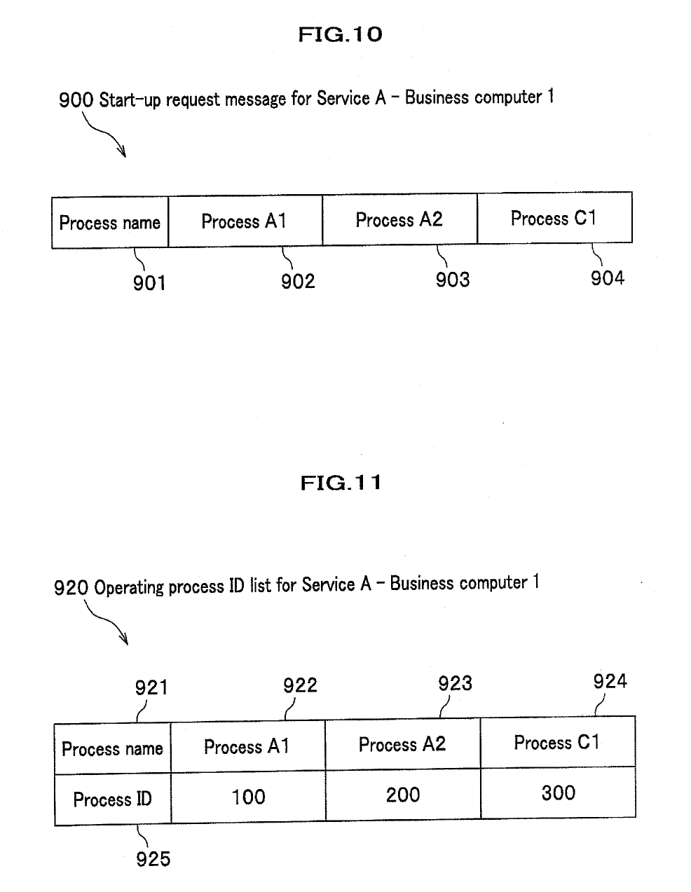

In step 803, the service start-up managing unit 14 obtains the process names registered for each business computer in the configuration table 172 obtained in step 801, and creates therefrom a start-up request message (list) (see FIG. 10). Then the procedure advances to step 804.

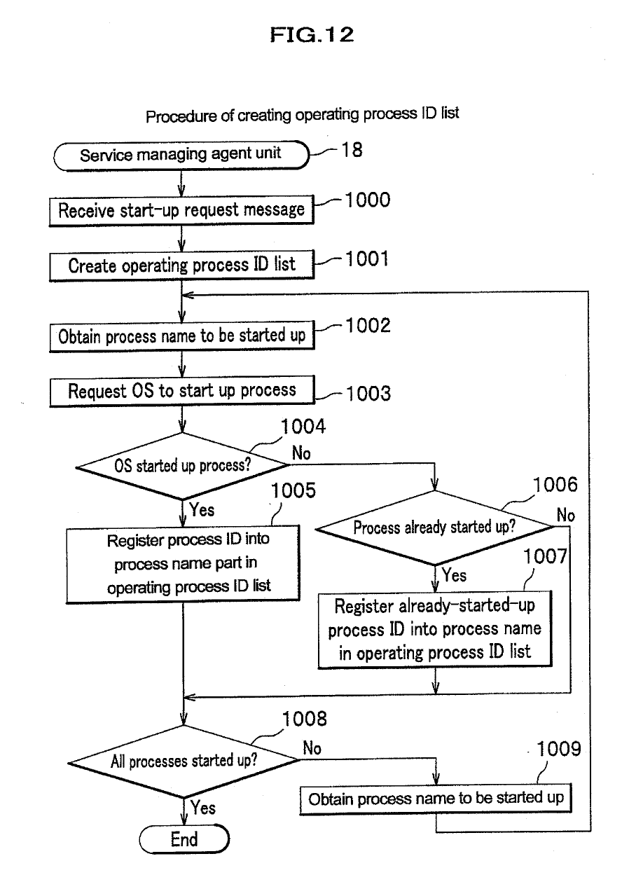

In step 804, the service start-up managing unit 14 sends the start-up request message created in step 803 to the service managing agent unit 18 (see FIG. 3) in the corresponding business computer. Namely, the service start-up managing unit 14 requests a start-up of the processes in each business computer in the configuration table 172. Then the service start-up managing unit 14 obtains an operating process ID list (see FIG. 11), in which process IDs having names of the started-up processes are registered. Then the procedure advances to step 805. Details of a procedure of obtaining the process IDs of the started-up processes will be described later with reference to FIG. 12.

In step 805, the service start-up managing unit 14 registers the process IDs registered in the operating process ID list (see FIG. 11) obtained in step 804, into appropriate columns in a row of the same business computer name in the operating process table 173 (see FIG. 8). Then the procedure advances to step 806.

In step 806, if the service start-up managing unit 14 has not yet sent all of the start-up request messages (see FIG. 10) created in step 803 to the business computers 40 (“No”), the procedure advances to step 807. If the service start-up managing unit 14 has already sent all the start-up request messages (“Yes”), the service start-up managing unit 14 terminates the procedure.

In step 807, the service start-up managing unit 14 obtains a name of a business computer which has not yet been requested for a start-up. Then the procedure returns to step 804.

FIG. 10 is a diagram showing the start-up request message 900. The service start-up managing unit 14 (see FIG. 1) sends the start-up request message 900 to the business computer 1 (400) for the service A (74), when the administrator requests a start-up of the service A (74). The service start-up managing unit 14 obtains and registers the process names of process A1 (902), process A2 (903), and process C1 (904), which are registered in a row of the business computer 1 (510) in the configuration table 172a for the service A (74). The service start-up managing unit 14 creates the start-up request message 900 therefrom.

FIG. 11 is a diagram showing an operating process ID list 920 (operating process ID information). In the operating process ID list 920, a process ID 925 of a started-up process is registered. The process is started-up by the service managing agent unit 18 in the business computer 40 according to the process name 901 (see FIG. 10) in the start-up request message 900 sent from the service start-up managing unit 14. The process ID with which the process A1 (922) in the operating process ID list 920 is operated is “100”. The process ID with which the process A2 (923) is operated is “200”. The process ID with which the process C1 (924) is operated is “300”.

FIG. 12 is a flowchart showing a procedure of creating the operating process ID list 920 (see FIG. 11), carried out by the service managing agent unit 18. In the procedure, when the service managing agent unit 18 in the business computer 40 receives the start-up request message 900 (see FIG. 10), the service managing agent unit 18 sequentially starts up processes having the process names 901 registered in the start-up request message 900. Then the service managing agent unit 18 obtains process IDs of the started up processes, and creates the operating process ID list 920 (see FIG. 11). The created operating process ID list 920 is used in step 805 of FIG. 9.

It is assumed herein that, even if a process requested for a start-up has already been started up and obtained a process ID thereof, the service start-up managing unit 14 can be started up and obtain the process ID again.

In step 1000, the service managing agent unit 18 receives the start-up request message 900 (see FIG. 10) from the service start-up managing unit 14. Then the procedure advances to step 1001.

In step 1001, the service managing agent unit 18 creates the operating process ID list 920 (see FIG. 11), which includes a process name 921 copied from the process name 901 (see FIG. 10) in the start-up request message 900. Then the procedure advances to step 1002.

In step 1002, the service managing agent unit 18 obtains any one of the process names (for example, the process A1) in the operating process ID list 920 created in step 1001. Then the procedure advances to step 1003.

In step 1003, the service managing agent unit 18 requests (instructs) the OS to start up a process having the process name obtained in step 1002. Then the procedure advances to step 1004.

In step 1004, the service managing agent unit 18 determines whether or not the process whose start-up has been requested in step 1003 is actually started up by the OS. If the process is actually started up (“Yes”), the procedure advances to step 1005. If the process is not actually started up (“No”), the procedure advances to step 1006.

It is to be noted that there are two types of processes. One type of a process can be doubly started up, even after the process has already been started up. The other type cannot. In step 1004, the process may or may not be started up according to the type of a process.

In step 1006, if the process of which name is obtained in step 1002 has been already started up (“Yes”), the procedure advances to step 1007. And if not (“No”), the procedure advances to step 1008.

If the process is not started up in step 1004 (“No”), there may be two major reasons. One may be that the process is of the latter type described above, and has already been started up. In this case, the process proceeds from step 1006 to “Yes”.

The other reason may be that the process itself is defective. For example, the process has already been deleted or is damaged. In this case, the process proceeds from step 1006 to “No”.

In step 1007, the service managing agent unit 18 registers a process ID into a process name corresponding thereto in the operating process ID list 920 (see FIG. 11) using the process ID of the process name obtained in step 1002, process of which has been already started up. Then the procedure advances to step 1008.

In step 1005, the service managing agent unit 18 registers a process ID into a process name corresponding thereto in the operating process ID list 920, using the process ID of the process name obtained in step 1002, process of which is newly started up. Then the procedure advances to step 1008.

In step 1008, the service managing agent unit 18 determines whether or not all of the process IDs are registered into the process names in the operating process ID list 920, namely, whether all processes are started up. If all the process IDs are registered (“Yes”), the process is terminated. If not all of the process IDs are registered (“No”), the procedure advances to step 1009.

In step 1009, the service managing agent unit 18 obtains a process name which has not yet obtained a process ID corresponding thereto in the operating process ID list 920 (for example, the process A2). Then the procedure returns to step 1003, and repeats the subsequent steps.

As described above, settings and definitions by the administrator and procedures made by the service managing apparatus 11 and the business computers 40 create the influence table 171, configuration table 172, and operating process table 173 on each service.

Next is described a procedure when a command is executed to a business program.

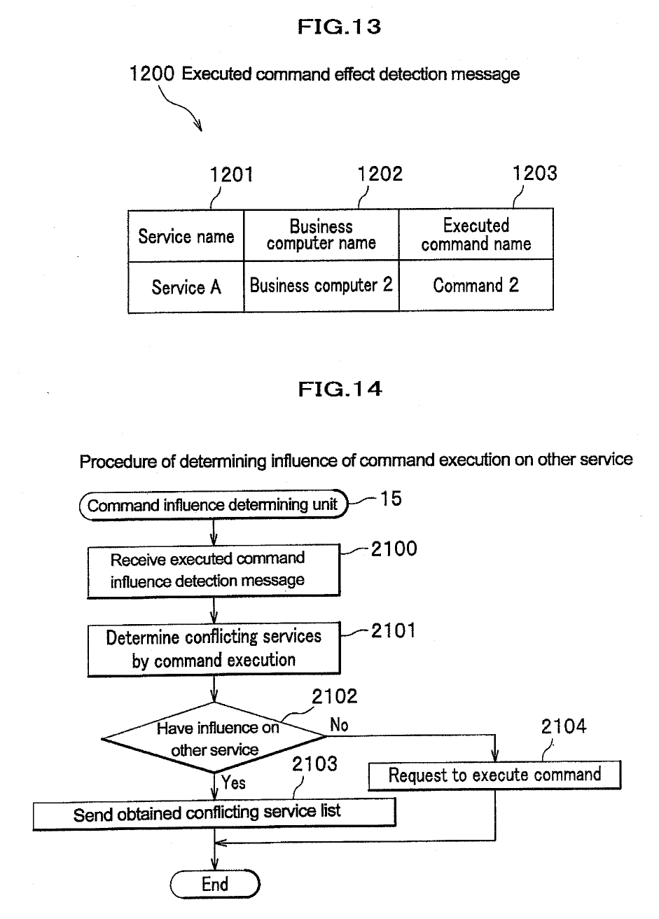

FIG. 13 is a diagram showing an executed command influence detection message 1200. In the procedure, the executed command influence detection message 1200 is created by the CPU 2731, when the administrator executes a command to a business program using the GUI 10. FIG. 13 assumes a case where the command 2 (411) (see FIG. 6) for the service A (74) is executed to the business computer 2 (401). In this case, the CPU 2731 (see FIG. 2) registers the service A (74) as a service name 1201, the business computer 2 (401) as a business computer name 1202, and the command 2 (411) as an executed command name 1203.

FIG. 14 is a flowchart showing a procedure of determining, when a command is executed to a service, an influence of an execution of the command on the other service(s), carried out by the command influence determining unit 15. In the procedure, the command influence determining unit 15 determines whether or not a command which is executed by the administrator to a business program for a service corresponding thereto exerts an influence on the other service(s).

In step 2100, the command influence determining unit 15 receives, from the service monitoring device 1 operated by the administrator, the executed command influence detection message 1200 (see FIG. 13) in which the command name 1203 to be executed, the service name 1201 corresponding thereto, and the business computer name 1202 in which the command is executed, are provided. Then the procedure advances to step 2101.

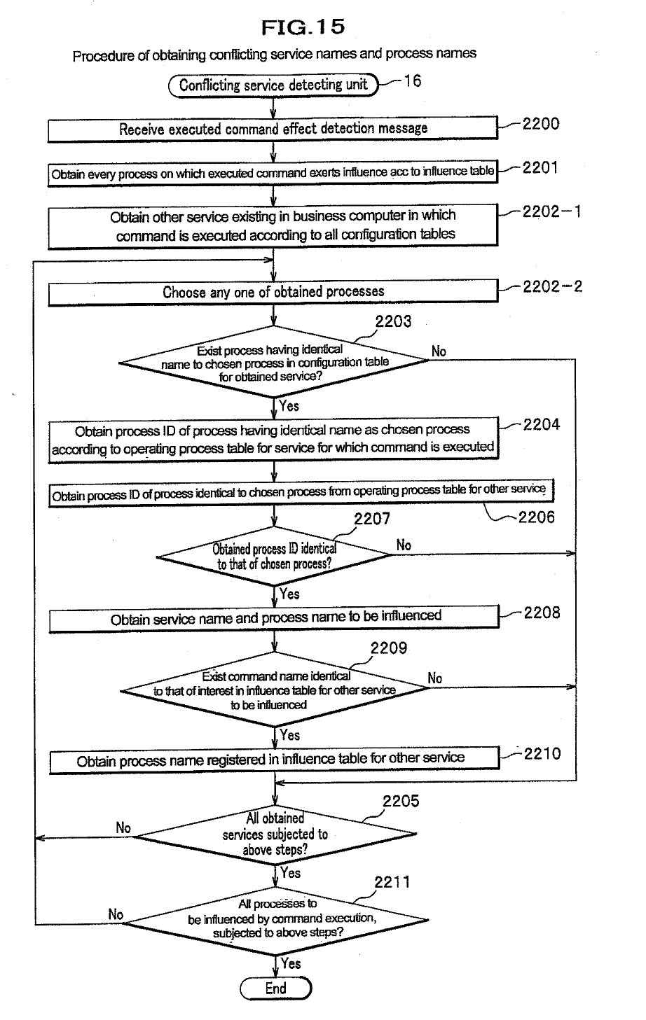

In step 2101, the command influence determining unit 15 sends the executed command influence detection message 1200 (see FIG. 13) received in step 2100 to the conflicting service detecting unit 16. The command influence determining unit 15 then obtains a conflicting service list 9200 (see FIG. 17) from the conflicting service detecting unit 16. The conflicting service list 9200 includes therein an influence of a command executed to a service on the other service(s), after the command is executed and a resultant conflict among the services is detected. Then the procedure advances to step 2102. Details of a procedure for detecting conflicting services resulting from the executed command (step 2101) will be described later in detail with reference to FIG. 15.

FIG. 17 shows a diagram showing the conflicting service list 9200. The conflicting service list 9200 includes therein names of a service (s) and a process (es) which is influenced by the command (1203), as a service name 9210 and a process name 9220, respectively.

Returning to FIG. 14, in step 2102, if the command influence determining unit 15 determines that there is a service name(s) registered as the service name 9210 (see FIG. 17) in the conflicting service list 9200 obtained in step 2101 (“Yes”), the procedure advances to step 2103. If the command influence determining unit 15 determines that there is not any service name registered as the service name 9210 (“No”), the procedure advances to step 2104.

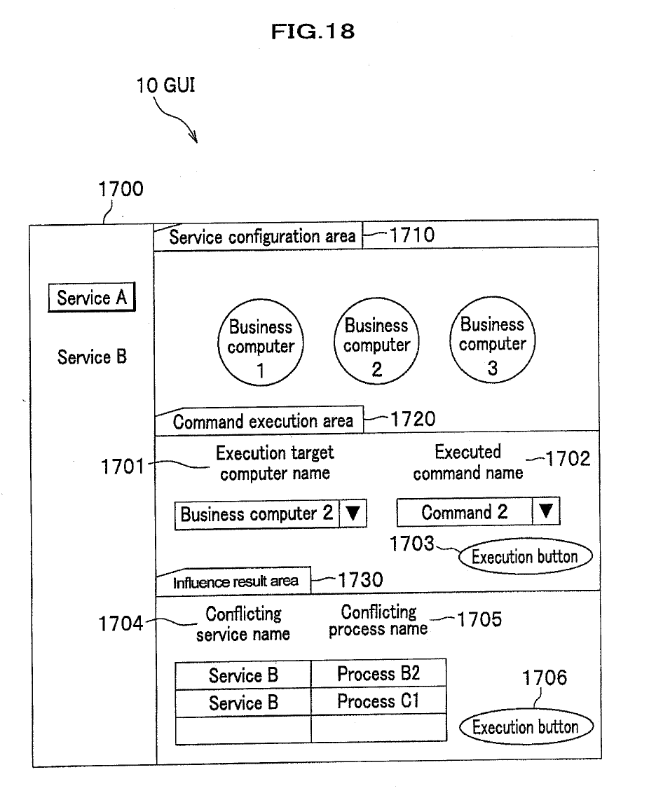

In step 2103, the command influence determining unit 15 sends the conflicting service list 9200 (see FIG. 17) received in step 2101 to the display processing unit 12 (see FIG. 1). Thus the procedure is terminated. After that, the display processing unit 12 sends the received conflicting service list 9200 to the service monitoring device 1, based on which the GUI 10 provides a display screen with appropriate information displayed thereon (to be described later in detail with reference to FIG. 18).

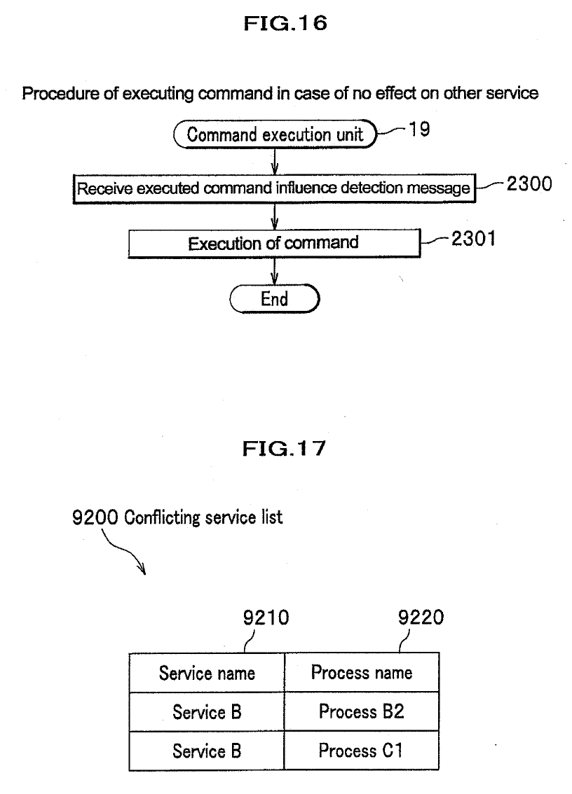

In step 2104, the command to be executed to a target service has already been determined to have no influence on the other services. The command influence determining unit 15 sends the executed command influence detection message 1200 (see FIG. 13) to the command execution unit 19 (see FIG. 1), which is to execute the command in the business computer 2 (401) (see FIG. 4). Thus the procedure is terminated. A subsequent procedure carried out by the command execution unit 19 is to be described later with reference to FIG. 16.

FIG. 15 is a flowchart showing a procedure of obtaining conflicting service names and process names thereof, carried out by the conflicting service detecting unit 16. In the procedure, the conflicting service detecting unit 16 determines whether or not a command to be executed to a service creates a conflict on the other service(s), using the influence table 171, configuration table 172, and operating process table 173. And if determined so, the conflicting service detecting unit 16 obtains names of conflicting services and process names thereof.

The procedure shown in FIG. 15 assumes that the “command 2” (411) (see FIG. 6) is executed to the “service A” (74) (see FIG. 4) in the “business computer 2” (401), as shown in the executed command influence detection message 1200 of FIG. 13.

In step 2200, the conflicting service detecting unit 16 receives the executed command influence detection message 1200 (see FIG. 13) from the command influence determining unit 15 (see FIG. 14). Then the procedure advances to step 2201.

In step 2201, the conflicting service detecting unit 16 obtains the influence table 171 corresponding to the service name 1201 included in the received executed command influence detection message 1200 (see FIG. 13). The conflicting service detecting unit 16 further obtains all of the process names provided in a row having the same command name as that to be executed (the “command 2”) according to the obtained influence table 171. Then the procedure advances to step 2202-1. Herein, the conflicting service detecting unit 16 obtains the process A2 (421) and process C1 (423) according to the influence table 171a of FIG. 6.

In step 2202-1, the conflicting service detecting unit 16 obtains, according to all of the configuration tables 172 created on each service, all names of the services constituted by a business computer(s) having the business computer name(s) 1202, in which a command having the executed command name 1203 included in the executed command influence detection message 1200 (see FIG. 13) received in step 2201 is executed. Then the procedure advances to step 2203. However, it is not necessary to obtain the service name (the “service A” itself) having been already received in step 2202-1 and included in the executed command influence detection message 1200. Herein the conflicting service detecting unit 16 obtains only the service B as the service name, because the configuration table 172b (see FIG. 7), which is obviously for the service other than the service A, shows that the service B also uses the business computer 2 (540).

In step 2202-2, the conflicting service detecting unit 16 chooses any one of the processes obtained in step 2201 (the “process C1”, for example). Only the chosen process is subjected to the subsequent steps.

In step 2203, the conflicting service detecting unit 16 determines whether or not the process name identical to that chosen in step 2202-2 exists in a row of the business computer name registered in the configuration table 172 (see FIG. 7) for the service name obtained in step 2202-1. If the conflicting service detecting unit 16 determines that the same process name exists (“Yes”), the procedure advances to step 2204. If the conflicting service detecting unit 16 determines that the same process name does not exist (“No”), the procedure advances to step 2205. Herein, the conflicting service detecting unit 16 obtains the process B1 (550) and process C1 (553) as the process names registered in the business computer 2 (540) in the configuration table 172b for the service B (see FIG. 7). Of the obtained process names, the process C1 (553) is the process chosen in step 2202-2, thus being the identical process name to that described in this step 2203.

In step 2204, the conflicting service detecting unit 16 obtains, according to the operating process table 173 (see FIG. 8) for the service name 1201 (see FIG. 13) registered in the executed command influence detection message 1200, a process ID of the process name obtained in step 2203 (commonly used in the services) and registered in a row of the business computer name, in business computer of which the command is executed. Then the procedure advances to step 2206. For example, in FIG. 8, the conflicting service detecting unit 16 obtains a process ID of “400” of the process C1 (623) registered in a row of the business computer 2 (611) in the operating process table 173a for the service A.

In step 2206, the conflicting service detecting unit 16 obtains, according to the process table 173 (see FIG. 8) for the other service name obtained in step 2202-1, a process ID of the process name registered in a row of the corresponding business computer and used in the service obtained in step 2203. Then the procedure advances to step 2207. For example, in FIG. 8, the conflicting service detecting unit 16 obtains a process ID of “400” of the process C1 (653) registered in a row of the business computer 2 (640) in the operating process table 173b for the service B.

In step 2207, the conflicting service detecting unit 16 compares the process ID (of a process used by a service to which a command is executed) obtained in step 2204, with the process ID (of a process used by the other service) obtained in step 2206, in the business computer 40 in which the command is to be executed. If the conflicting service detecting unit 16 determines that the two process IDs are identical (“Yes”), the procedure advances to step 2208. If the conflicting service detecting unit 16 determines that the two process IDs are different (“No”), the procedure advances to step 2205. For example, in FIG. 8, the process ID of the process C1 (623) for the common program C1 (205) (see FIG. 4) in the business computer 2 (611) for the service A in the operating process table 173a is identical to the process ID of the process C1 (625) for the common program C1 (205) in the business computer 2 (640) for the service B in the operating process table 173b, both of the process IDs being “400”.

If the two process IDs are identical (“Yes”) in step 2207, the command to be executed to a service exerts an influence on the other service. In step 2208, the conflicting service detecting unit 16 obtains a name of the service to be exerted an influence and a name of the commonly used process. The conflicting service detecting unit 16 registers the service name and the process name into a service name 9210 and into a process name 9220 respectively in the conflicting service list 9200 (see FIG. 17). Then the procedure advances to step 2209. Herein the conflicting service detecting unit 16 registers the service B as the service name 9210 to be exerted an influenced and the process C1 as the process name 9220.

In step 2209, the conflicting service detecting unit 16 determines whether or not a command having the same name as the command to be executed (1203) (see FIG. 13) is registered in the influence table 171 (see FIG. 6), which includes the service name determined to receive an influence of the command in step 2208. If the conflicting service detecting unit 16 determines that the command is registered in the influence table 171 (“Yes”), the procedure advances to step 2210. If the conflicting service detecting unit 16 determines that the command is not registered in the influence table 171 (“No”), the procedure advances to step 2205. For example, in FIG. 6, the command 2 (441) having the same name as the command 2 (1203) (see FIG. 13) in the executed command influence detection message 1200 is registered in the influence table 171b for the service B.

In step 2210, the conflicting service detecting unit 16 obtains the process name(s) registered in the influence table 171 (see FIG. 6) for the service(s) other than a target service (which means that the process is influenced by the command). The conflicting service detecting unit 16 registers the obtained process name into the process name 9220 (see FIG. 17) in the conflicting service list 9200. Then the procedure advances to step 2205. For example, in FIG. 6, the conflicting service detecting unit 16 obtains the process B2 (451) and process C1 (453) registered in a row of the command 2 (441) in the influence table 171b for the service B, and registers the obtained process names into the process name 9220 (see FIG. 17) in the conflicting service list 9200.

In step 2205, the conflicting service detecting unit 16 determines whether or not all of the service names obtained in step 2202-1 in the business computer 40 in which the command is executed are subjected to step 2203 and thereafter. If all of the service names are subjected to the steps (“Yes”), the procedure advances to step 2211. If not all of the service names are subjected to the steps (“No”), the conflicting service detecting unit 16 obtains a service name(s) not yet subjected to the steps from the service names obtained in step 2202-1. Then the procedure returns to step 2203.

In this embodiment, the service B is the only service that exists other than the service A. Thus the procedure naturally proceeds from step 2205 to “Yes”. However, if a plurality of services B, C, . . . exist as the services other than the service A, the procedure may proceed from step 2205 to “No” until all of the services other than the service A are subjected to step 2203 and thereafter.

In step 2211, the conflicting service detecting unit 16 determines whether or not all of the process names obtained in step 2201 (namely, the process names registered in a row of the command name to be executed in the influence table (see FIG. 6) for a service to which the command is executed) are subjected to step 2203 and thereafter. If the conflicting service detecting unit 16 determines that all of the services are subjected to the steps (“Yes”), the procedure is terminated. If the conflicting service detecting unit 16 does not determine so (“No”), the procedure returns to step 2202-2. Then the conflicting service detecting unit 16 chooses any other process, which is subjected to step 2203 and thereafter. For example, in FIG. 6, the command 2 in the influence table 171a for the service A exerts an influence not only on the process C1 (423) but also on the process A2 (421). In this case, the procedure returns to step 2203, and the conflicting service detecting unit 16 detects an influence of the process A2 (421) on the other service(s). The conflicting service detecting unit 16 then determines in step 2203 that the process A2 (421) does not exert any influence on the service B, because the process A2 (421) does not exist in the configuration table 172b (see FIG. 7) for the service B (If “No” in step 2203, the procedure advances to step 2205).

The procedure described above shows that, when the command 2 (1203) (see FIG. 13) for the service A (1201) is executed in the business computer 2 (1202) as shown in the executed command influence detection message 1200, the command 2 (1203) exerts an unintended influence on the service B; and the command 2 (1203) also exerts an influence on the process C1 (453) (see FIG. 6) and process B2 (451) used by the service B.

FIG. 16 is a flowchart showing a procedure of executing a command in case of no influence exerted on the other service, carried out by the command execution unit 19. In the procedure, the command execution unit 19 executes a command to a service, which is determined to exert no influence on the other services by the command influence determining unit 15 (see FIG. 14). The procedure is carried out after step 2104 in FIG. 14.

In step 2300, the command execution unit 19 receives the executed command influence detection message 1200 (see FIG. 13) from the command influence determining unit 15. The command execution unit 19 obtains the execution command name 1203, of which command is to be executed, from the executed command influence detection message 1200. Then the procedure advances to step 2301.

In step 2301, the command execution unit 19 requests the OS to execute the command having the execution command name 1203 obtained in step 2300.

FIG. 18 is a diagram showing a display screen for informing the administrator of a result of an influence exerted by a command to be executed to a service on the other services. The result is detected by the command influence determining unit 15 (see FIG. 14) as described above. The display screen is provided by the GUI 10 under instruction from the display processing unit 12 (see FIG. 1) in the service managing apparatus 11. It is assumed herein that the “command 2” is executed to the “service A” in the “business computer 2” as shown in the executed command influence detection message 1200 of FIG. 13.

In FIG. 18, the administrator selects the “service A” out of the “service A” and “service B” in an area 1700, which is located on an upper left of the display screen of the GUI 10.

Upon selection, the “business computer 1”, “business computer 2”, and “business computer 3”, which are the business computers constituting the service A, are displayed in a service configuration area 1710.

The administrator selects, in a command execution area 1720, the “business computer 2” as an execution target computer name 1701, further selects the “command 2” as an execution command name 1702, and clicks an execution button 1703. This operation creates the executed command influence detection message 1200 shown in FIG. 13, in the service monitoring device 1 (see FIG. 1).

The executed command influence detection message 1200 is sent to the service managing apparatus 11 (see FIG. 1). If it is determined that an execution of the command to the service A does not exert any influence on the other services (“No” in step 2102 of FIG. 14), the command is executed (step 2104 of FIG. 14).

On the other hand, if it is determined that the execution of the command to the service A exerts an influence on the other services (“Yes” in step 2102 of FIG. 14), the service name 9210 and the process name 9220 (see FIG. 17) to be influenced are displayed as a conflicting service name 1704 and a conflicting process name 1705 respectively, in an influence result area 1730.

The administrator checks what is displayed as the conflicting service name 1704 and the conflicting process name 1705 in the influence result area 1730. The administrator may determine therefrom that the execution of the command does not exert any negative influence on the other service(s), because, for example, the service displayed as the conflicting service name 1704 is not being operated at the moment. In this case, the administrator may force the execution of the command. Namely, the administrator just clicks an execution button 1706. With this operation, the executed command influence detection message 1200 (see FIG. 13) is sent to the command execution unit 19 (see FIG. 16) in a computer having the execution target computer name 1701, in which the command is executed, to thereby force the command to be executed.

As described above, the embodiment of the present invention can reduce an administrator's checking operation of a system constituted by a plurality of services, by detecting in advance an influence of an operation to a service made by the administrator on the other services. The embodiment can also avoid an unintended influence on the system that may arise due to an improper operation by the administrator.

The embodiment of the present invention is not limited to the above-mentioned description.

For example, the embodiment assumes that a command exerts an influence on a “process”. However, the command may exert an influence on a “job”, which may be constituted by a plurality of processes or tasks.

Other various modifications and variations to specific configurations of hardware, flowcharts, and the like of the present invention are possible without departing from the spirit and scope of the claims.

1. A service managing system comprising: a plurality of business computers, each of which provides a plurality of services, each of which is constituted by a plurality of business programs; and a service managing apparatus communicably connected to each of the business computers,
wherein the service managing apparatus includes a processing unit and a storage unit,
the storage unit stores influence information on each of the services, the influence information is composed of data on a start-up instruction of a first process targeted to be started up and data on a second process to be influenced by the start-up instruction, the data on the first process and the data on the second process are associated with each other, and a process indicates a business program in execution, and
the storage unit further stores configuration information on each of the services, the configuration information is composed of data on a business computer and data on a third process which is started up by the business computer, and the data on the business computer and the data on the third process are associated with each other; and
wherein the processing unit references the influence information and configuration information stored in the storage unit, when the processing unit gives a start-up instruction of a first process to any of the business computers, and
the processing unit identifies the second process and a service corresponding to the second process to be influenced by the start-up instruction, using the influence information and configuration information.

2. The service managing system according to claim 1,
wherein the storage unit in the service managing apparatus further stores operating process information on each of the services, the operating process information is composed of data on each of the business computers, and a process ID assigned to the third process started up by each of the business computers and unique to each of the business computers, and the data on each of the business computers and the process IDs are associated with each other; and
wherein the processing unit
references the influence information stored in the storage unit, when the processing unit gives a start-up instruction of the first process to any of the business computers, and identifies the second process and a service corresponding to the second process to be influenced by the start-up instruction, using the influence information,
further references the configuration information in the storage unit, and determines whether or not the identified second process exists in a business computer providing the identified service,
further references the operating process information in the storage unit, if the identified second process exists in the business computer providing the identified service, obtains two process IDs, one being a process ID of the first process to be executed by the start-up instruction, the other being a process ID of the identified second process, and determines that, if the two process IDs are identical, the identified second process is influenced by the start-up instruction.

3. The service managing system according to claim 2, wherein the processing unit in the service managing apparatus creates the operating process information in the storage unit, based on operating process ID information, and the operating process ID includes a process ID of the third process operating in each of the business computers and is received from each of the business computers.

4. The service managing system according to claim 1, wherein the start-up instruction is a command including a set of character strings, and the command directly gives an instruction to a business program.

5. The service managing system according to claim 1, wherein the processing unit in the service managing apparatus gives a start-up instruction of the first process to any of the business computers, based on a start-up instruction of the first process to the business computer inputted from either an input unit in the service managing apparatus or an input unit in an external device connected to the service managing apparatus.

6. The service managing system according to claim 1, wherein the processing unit makes either a display unit in the service managing apparatus or an input unit in an external device connected to the service managing apparatus display at least either the second process or the service identified to be influenced by the start-up instruction.

7. A service managing apparatus communicably connected to a plurality of business computers, each of which provides a plurality of services, each of which is constituted by a plurality of business programs, the service managing apparatus comprising:
a storage unit for storing influence information on each of the services, the influence information being composed of data on a start-up instruction of a first process targeted to be started up and data on a second process to be influenced by the start-up instruction, the data on the first process and the data on the second process being associated with each other, and a process indicating a business program in execution, and the storage unit for further storing configuration information, the configuration information being composed of data on a business computer and data on a third process which is started up by the business computer, and the data on the business computer and the data on the third process being associated with each other; and
a processing unit for referencing the influence information and configuration information stored in the storage unit, when the processing unit gives a start-up instruction of a first process to any of the business computers, and
the processing unit identifying the second process and a service corresponding to the second process to be influenced by the start-up instruction, using the influence information and configuration information.

8. The service managing apparatus according to claim 7, comprising:
a receiving unit for receiving an executed command influence detection message including a start-up instruction of the first process, information for identifying a service, and information on the business computer in which the start-up instruction is executed; and
a conflicting service detecting unit for determining, from the received executed command influence detection message, whether or not the start-up instruction of the first process creates a conflict on the services, using the influence information, configuration information, and operating process information stored in the storage unit, the operating process information being composed of data on each of the business computers and a process ID assigned to the third process started up by each of the business computers and unique to each of the business computers, and the data on each of the business computers and the process ID being associated with each other.

9. The service managing apparatus according to claim 8, further comprising: an influence process obtaining unit for obtaining, according to an influence information table with the influence information stored therein, the second process to be influenced by the start-up instruction and stored in the service identifying information included in the executed command influence detection message.

10. The service managing apparatus according to claim 9, further comprising: a related service information obtaining unit for obtaining, according to a configuration information table with the configuration information stored therein, every service ID, of which the service is started up in the business computer in which the start-up instruction included in the executed command influence detection message is executed.

11. The service managing apparatus according to claim 10, further comprising: a process influence determining unit for determining whether or not exists the second process to be influenced by the start-up instruction on a service other than the service included in the executed command influence detection message, by determining whether or not the second process to be influenced by the start-up instruction on the service exists in the business computer included in the configuration information table on the service obtained in the related service information obtaining unit.

12. The service managing apparatus according to claim 11, further comprising a process ID obtaining unit for obtaining an ID of the process influenced by the start-up instruction in the business computer, according to an operating process table with the operating process information stored therein, using the service IDs included in the executed command influence detection message, if the second process influenced by the start-up instruction on the other service exists in the business computer.

13. A service managing method by a service managing apparatus communicably connected to a plurality of business computers, each of which provides a plurality of services, each of which is constituted by a plurality of business programs,
wherein the service managing apparatus includes a processing unit and a storage unit,
the storage unit stores influence information on each of the services, the influence information is composed of data on a start-up instruction of a first process targeted to be started up and data on a second process to be influenced by the start-up instruction, the data on the first process and the data on the second process are associated with each other, and a process indicates a business program in execution, and
the storage unit further stores configuration information on each of the services, the configuration information is composed of data on a business computer and data on a third process which is started up by the business computer, and the data on the business computer and the data on the third process are associated with each other; and
wherein the processing unit references the influence information and configuration information stored in the storage unit, when the processing unit gives a start-up instruction of a first process to any of the business computers, and
the processing unit identifies the second process and a service corresponding to the second process to be influenced by the start-up instruction, using the influence information and configuration information.

14. The service managing method according to claim 13,
wherein the storage unit in the service managing apparatus further stores operating process information on each of the services, the operating process information is composed of data on each of the business computers, and a process ID assigned to the third process started up by each of the business computers and unique to each of the business computers, and the data on each of the business computers and the process IDs are associated with each other; and
wherein the processing unit
references the influence information stored in the storage unit, when the processing unit gives a start-up instruction of the first process to any of the business computers, and identifies the second process and a service corresponding to the second process to be influenced by the start-up instruction, using the influence information,
further references the configuration information in the storage unit, and determines whether or not the identified second process exists in a business computer providing the identified service,
further references the operating process information in the storage unit, if the identified second process exists in the business computer providing the identified service, obtains two process IDs, one being a process ID of the first process to be executed by the start-up instruction, the other being a process ID of the identified second process, and determines that, if the two process IDs are identical, the identified second process is influenced by the start-up instruction.

15. The service managing method according to claim 14, wherein the processing unit in the service managing apparatus creates the operating process information in the storage unit, based on operating process ID information, and the operating process ID includes a process ID of the third process operating in each of the business computers and is received from each of the business computers.

16. The service managing method according to claim 13, wherein the start-up instruction is a command including a set of character strings, and the command directly gives an instruction to a business program.

17. The service managing method according to claim 13, wherein the processing unit in the service managing apparatus gives a start-up instruction of the first process to any of the business computers, based on a start-up instruction of the first process to the business computer inputted from either an input unit in the service managing apparatus or an input unit in an external device connected to the service managing apparatus.

18. The service managing method according to claim 13, wherein the processing unit makes either a display unit in the service managing apparatus or an input unit in an external device connected to the service managing apparatus display at least either the second process or the service identified to be influenced by the start-up instruction.

19. The service managing apparatus according to claim 12, further comprising a conflicting service list output unit for obtaining the other service and the second process corresponding to the other service influenced by the start-up instruction to be executed, if exists a process ID on the other service having the same ID as the process ID obtained according to the operating process table, in the business computer in which the start-up instruction is executed; and
the conflicting service list output unit further for outputting the obtained other service and the second process as a conflicting service list.
